(19) United States
(12) Patent Application Publication
(10) Pub. No.: US 2004/0054524 A1
(43) Pub. Date: Mar. 18, 2004

(54) Speech transformation system and apparatus

(76) Inventor: Shlomo Baruch, Ashdod (IL)

Correspondence Address: Eitan Pearl Latzer & Cohen Zedek, Suite 1001, 10 Rockefeller Plaza, New York, NY, 10020, US

(21) Appl. No.: 10/432,610

(22) PCT Filed: Dec. 4, 2001
(86) PCT No.: PCT/IL01/01118

(30) Foreign Application Priority Data
Dec. 4, 2000 (IL) 140082

(51) Int. Cl. G10L 19/00

(52) U.S. Cl. 704/201

(57) ABSTRACT

The invention relates to the production of sounds representing the speech of a chosen individual. The invention provides a system and an apparatus which enables a first person to speak in the normal manner characteristic of him/herself the sound being electronically transformed and made audible to a hearer as if the text had been spoken by a second person. The system comprises means for loading speech samples into a storage memory, the memory being connected to a digital processing unit and means for recording speech samples by the first and by a second person, and means for analysis of the speech, the analysis including at least two of the group of five voice characteristics, the group comprising pitch, voice, unvoice, silence, and energy, the analysis being converted to digital form and being accessible by the digital processing unit and a program for directing operation of the digital processing unit to produce conversion factors for converting the vocal output of the first person into speech signals as would be produced if spoken by the second person; and a vocal output means for receiving processed signals firm the digital processing unit for broadcasting speech by the first person in a third person manner, the third person manner speech sounding as if spoken by the second person.

The present invention relates to the production of sounds representing the speech of a chosen individual.

More particularly, the invention provides a system and an apparatus which enables a first person to speak in the normal manner characteristic of him/herself the sound being electronically transformed and made audible to a hearer as if the text had been spoken by a second person.

In the production of moving pictures, television footage, advertising material, or in theater plays there is an occasional need to produce material requiring the voice of an actor or other person who is presently unavailable to produce the required material. Sometimes an actor has difficulty speaking a required language and another person is required for this task. Cartoon characters and cartoon animals may be required to speak in a defined tone of voice, which is unavailable to the film producer. Law enforcement officers may have an opportunity of trapping a criminal by telephone by inviting same to meet a person known to him/her at an agreed time. To meet these requirements, voice or speech transformation systems have been developed.

In U.S. Pat. No. 5,029,211 Ozawa discloses a speech analysis and synthesis system, which operates to determine a sound source signal for the interval of each speech unit which is to be used for speech synthesis, according to a spectrum parameter obtained from each speech unit based on spectrum. The system includes means for storage, synthesis and filtering to remove spectral distortion.

A method and apparatus for altering the voice characteristics of synthesized speech is disclosed by Blanton et al. in U.S. Pat. No. 5,113,449. A vocal tract model of digital speech data is altered but the original pitch period is maintained. The invention is intended primarily to produce sound from fanciful sources such as talking animals and birds.

The shifting of the pitch of a sound signal is the subject of U.S. Pat. No. 5,862,232 by Shinbara et al. Sound signals are divided into a series of multiple frames in an envelope. These are converted into a frequency domain by a Fourier transform. After changes are made the process is reversed.

The prior art does not provide for effecting changes to voice signals so that a first voice is transformed into a second voice with high fidelity. Such transformation can only be effected accurately when several voice parameters are processed—including speed of speech.

It is therefore one of the objects of the present invention to obviate the disadvantages of prior art voice transformation systems and to provide a system and an apparatus which carry out this task with improved fidelity.

It is a further object of the present invention to adapt such a system for use on a personal computer, on a local area network and on an open network.

The present invention achieves the above objects by providing an improved speech transformation system for converting vocal output of a first person into speech as would be heard if spoken by a second person, the system comprising:

a) means for loading speech samples into a storage memory, said memory being connected to a digital processing unit;

b) means for recording speech samples by said first and by a second person, and means for analysis of said speech, said analysis including at least two of the group of five voice characteristics, said group comprising pitch, voice, background, silence, and energy, said analysis being converted to digital form and being accessible by said digital processing unit;

c) a program for directing operation of said digital processing unit to produce conversion factors for converting said vocal output of said first person into speech signals as would be produced if spoken by said second person; and

d) vocal output means for receiving processed signals from said digital processing unit, for broadcasting speech by said first person in a third person manner, said third person manner speech sounding as if spoken by said second person.

In a preferred embodiment of the present invention there is provided a speech transformation system wherein the recorded speech signals of both said first and second persons are sliced by software and hardware for purposes of said analysis into adjoining segments no larger than 10 milliseconds each.

In a most preferred embodiment of the present invention there is provided a speech transformation system wherein said digital processing unit is the central processing unit of a personal computer, said vocal output means is the tone generator of said personal computer, and said program is recorded on a disk acceptable by said computer.

Yet further embodiments of the invention will be described hereinafter.

In U.S. Pat. No. 5,327,521 by Savic et al. there is described and claimed a high quality voice, transformation system which operates during a training mode to store, voice signal characteristics representing target and source voices. Thereafter, during a real time transformation mode, a signal representing source speech is segmented into overlapping segments, analyzed to separate the excitation spectrum from the tone quality spectrum. A stored target tone quality spectrum is substituted for the source spectrum and then convolved with the actual source speech excitation spectrum. The produced speech has the word and excitation content of the source, but the acoustical characteristics of a target speaker.

In the opinion of the present inventor, the system described by Savic et al. will not produce high-fidelity results as too few speech characteristics are measured and processed. Furthermore, the use of 30 millisec segments will produce poor results, particularly in fast-spoken speech. In contradistinction thereto, the present invention measures and processes up to 5 speech characteristics and processes speech slices 10 millisec long. Furthermore, the system of the present invention is executed in hardware and software.

It is recognized that receiving, processing and outputting large quantities of voice data in real time, without perceptible delay, calls for very fast data processing. In the present invention this requirement is met by the use of a Digital Signal Processor (hereinafter DSP). The distinguishing feature of the DSP is its power to perform complex mathematical calculations at high speeds, partly due to the use of separate address and data busses. An example of a commercially available DSP is the TMS320C5510 made by Texas Instruments.

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

### IN THE DRAWINGS

FIG. 1 is a block diagram of a preferred embodiment of the system according to the invention, wherein voice signals are fed to a data bank for storage;

FIG. 2 is a block diagram showing the transformation procedure;

FIG. 3 is a non-detailed block diagram representing a system equipped with a microphone and loudspeaker;

FIG. 4 is a diagrammatic view of the system adapted to a personal computer;

FIG. 5 is a block diagram of the system adapted to a local area network;

FIG. 6 is a block diagram of the system adapted to an open network;

FIG. 7 is a schematic view of a device arranged to use the voice transformation system;

FIG. 8 is a block diagram of a procedure for use of the device of FIG. 7; and

FIG. 9 is a block diagram of a procedure for use of a device similar to that of FIG. 7, further provided with a data bank.

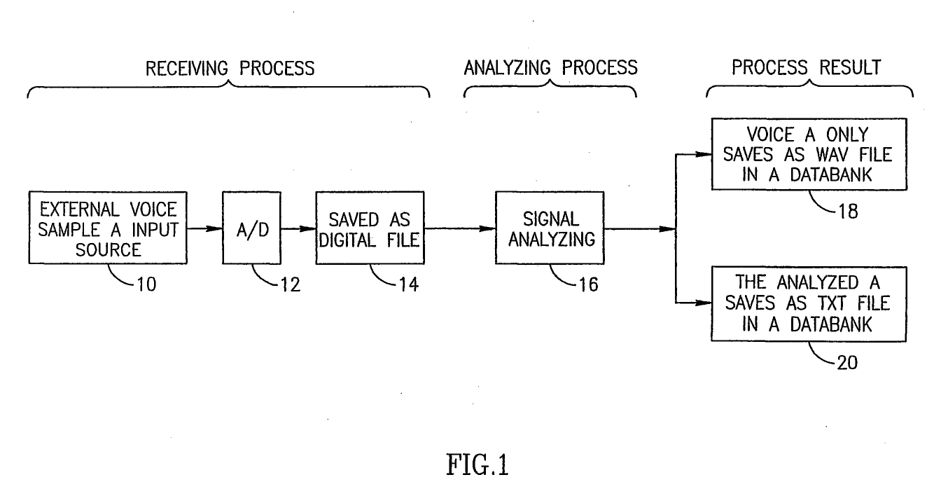

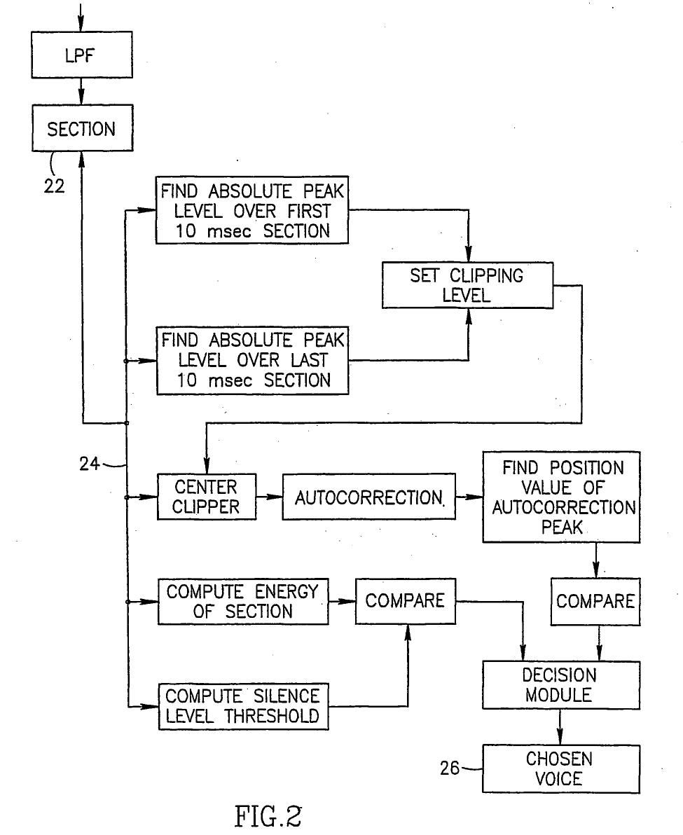

There is seen in FIGS. 1 and 2 a representation of an improved speech transformation system for converting vocal output of a first person into speech as would be heard if spoken by a second person.

FIG. 1 represents in non-detailed form the training mode of the system.

Means for loading speech, such as external voice sample A 10 is used as an input source. The speech sample 10 can be available on a tape or disk, and is connected to an analogue/digital converter 12. The result is stored in a digital storage memory as a file 14. The voice signals are analyzed 16, and sent to a WAV file 18. The signals are then processed in a digital processing unit and sent to a TXT file 20 in a data bank.

During training, means are provided for recording speech samples by a first and by a second person. FIG. 2, labeled to be self explanatory, shows means for analysis of both speech samples. Preferably, the recorded speech signals of both first and second persons are sliced 22 by software and hardware for purposes of analysis into adjoining segments no larger than 10 milliseconds each.

The analysis includes at least two of five voice characteristics: pitch, voice, background, silence, and energy. FIG. 2 also shows the operation of the digital processing unit.

A program 24 is provided for directing operation of the digital processing unit. The program produces conversion factors for converting the vocal output of the first person into speech signals as would be produced if spoken by said second person.

Vocal output means 26, for example earphones, a tape or disk recording are provided for receiving processed signals from the digital processing unit, for broadcasting speech by the first person in a third person manner. The third person manner speech now sounds as if spoken by the second person.

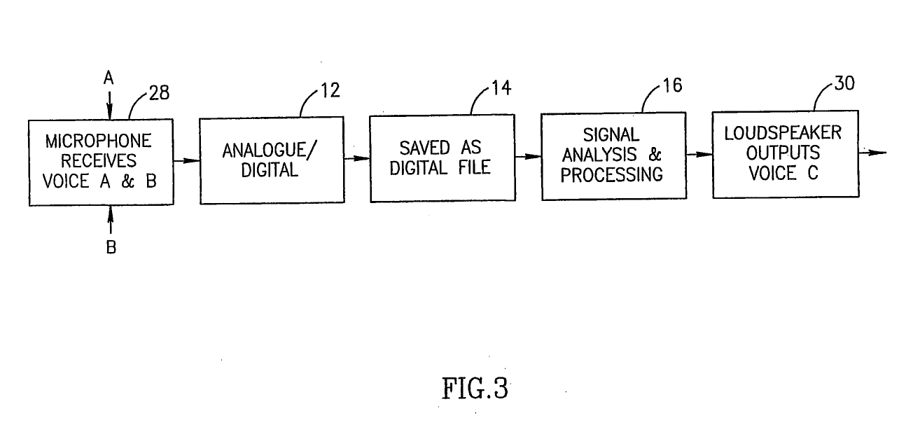

FIG. 3 illustrates in abbreviated form training and operation of a typical speech transformation system.

Means for loading speech samples into a storage memory comprises a microphone 28, and vocal output means comprises a loudspeaker 30. Processing is the same as in FIG. 1.

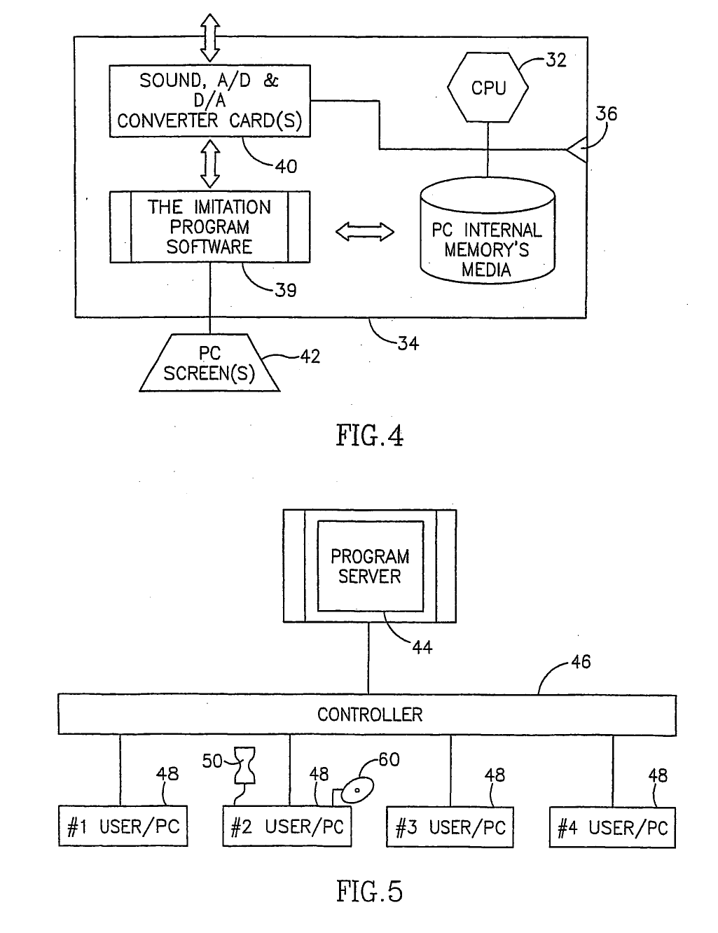

Seen in FIG. 4 is a representation of a speech transformation system wherein the digital processing unit is the central processing unit 32 of a personal computer 34. The vocal output means is the tone generator 36 of the personal computer. The imitation program 38 is recorded as software on a disk, e.g. 3.5 “floppy or CD ROM or DVD which is acceptable by the computer.

If not already installed, the computer receives added analogue/digital and D/A converter cards 40.

The computer screen monitor 42 is used for checking progress and optionally also for displaying waveforms.

Referring now to FIG. 5, there is depicted a block diagram of a speech transformation system adapted for use on a local area network, for example Ring and Intranet.

The digital processing unit and the central processing unit are part of a server program 44. The server is connected through a controller 46 in a closed network to multiple network computers 48. Each computer has a connected speech loading means 50 for voice input, for example a microphone, and a vocal output means 52 for resultant output, for example a recording disk.

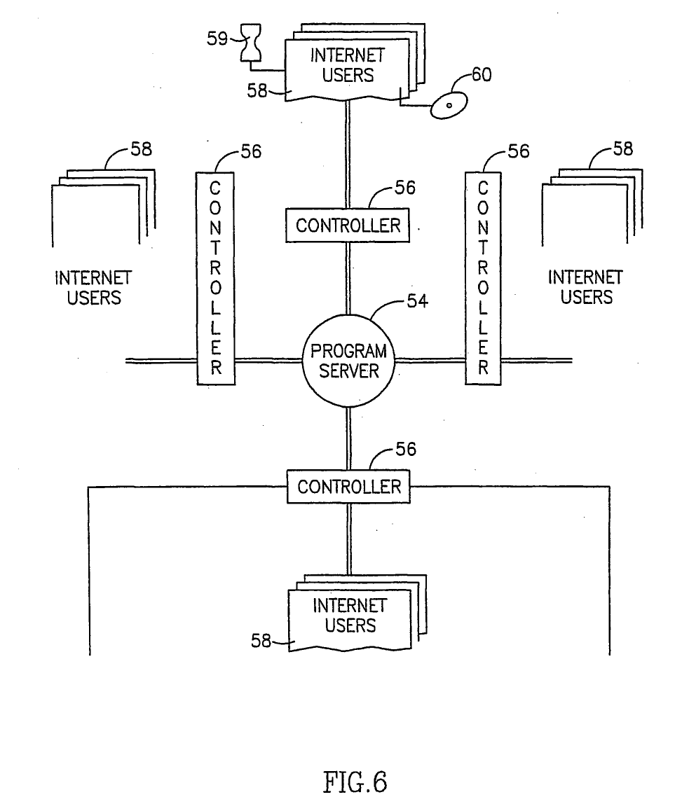

FIG. 6 shows a speech transformation system adapted for Internet use.

A digital processing unit and a central processing unit are part of a server program 54 connected through a plurality of controllers 56 in an open network to computers 58 connected to the internet. Each computer 58 has a connected microphone 59 for voice input and sound recording means 60 for resultant output.

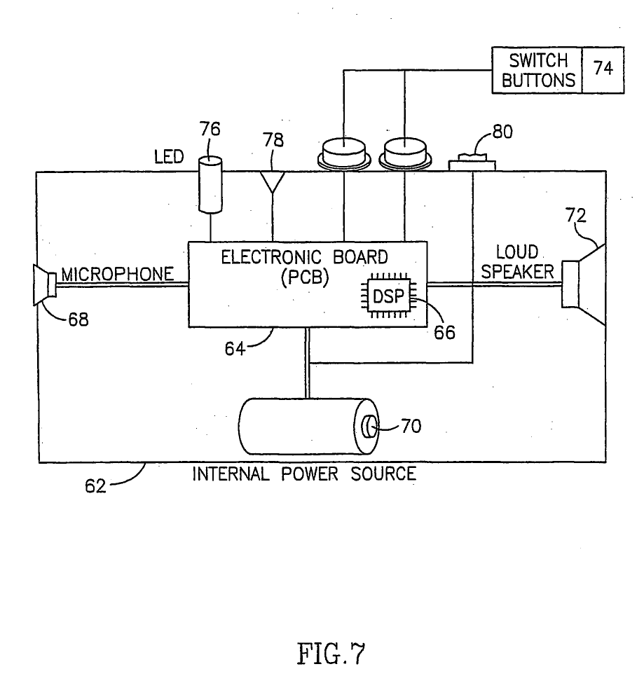

FIG. 7 illustrates a portable speech conversion device.

A housing 62 contains an electronic board 64 including a DSP chip 66 and all modules needed to execute speech conversion. Most of the conversion program is executed by use of these electronic components. The device also includes a microphone 68, an internal power source such as a battery 70, a loudspeaker 72, and switch buttons 74 for user controls.

Advantageously the device further includes at status-indicating light 76, typically a 3-color-changing LED, red green and yellow, a tone generator 78, and a power on/off switch 80.

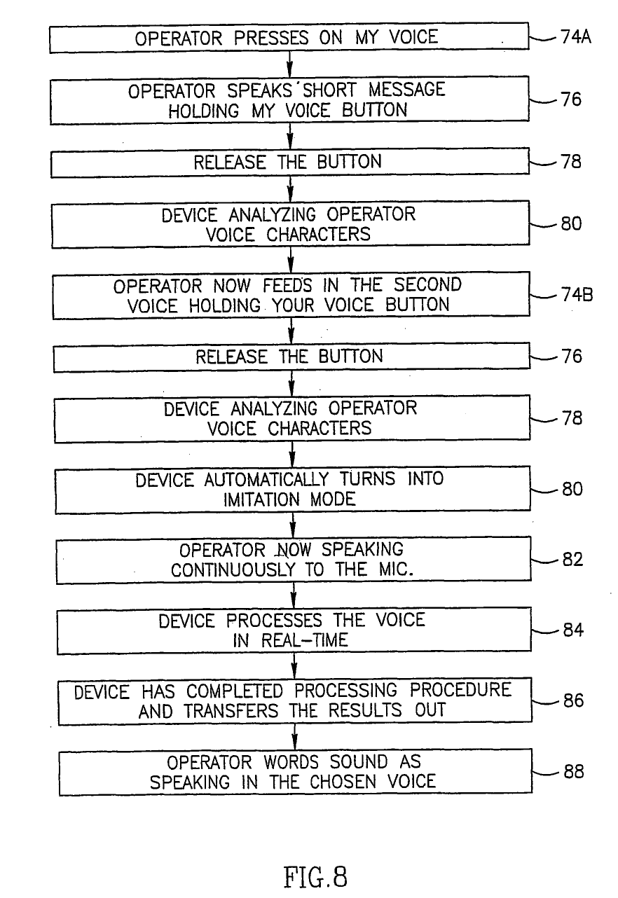

Seen in FIG. 8 is a diagram representing training and use of the device described with reference to FIG. 7.

As power is switched on, the LED displays a green light Operator presses on the “MY VOICE” button 74a, which opens analogue path no. 1 of the DSP. When the system is ready it emits a short tone. The LED turns red, signing entering a recording mode.

While still pressing the “MY VOICE” button, the operator speaks a short sentence 76-which can be predetermined to include all normal types of speech sounds. The device converts the voice into digital form. The process ends when the operator releases the button 78, or after processing is completed and the device emits a tone signifing completion. The LED changes to yellow.

The device in training mode now “learns” 80 the operator's voice.

Digital filtering of the voice signals is carried out in the DSP so as to form a new voice file of the speech limited to a width of 3 kHz. High tones are removed. The speech is chopped into 10 millisec segments, and processed 82 as elaborated in FIG. 2. The results are stored in memory as a series of calculation factors defining voice characteristics including silence, speech pitch and unvoice.

The operator now presses the “YOUR VOICE” button 74b which opens analogue path no. 2 of the DSP. When the system is ready it emits a short tone. The LED turns red, signifying entering a recording mode.

While still pressing the “YOUR VOICE” button, the operator feeds in a short sentence of the voice to be copied. The device converts the voice into digital form. The recording finishes and the operator releases the button 76. After analysis and processing 78 are completed and the device emits a tone signifying completion. The LED changes to yellow.

The device automatically goes into “Imitation” mode 80, which opens analogue path no. 3 of the DSP to receive current data on background noise, or alternately on silence, for processing.

The operator talks in a normal voice 82. The DSP accumulates digital data in bytes no larger than 10 millisecs each 84. The process loop repeats continuously.

The digital processing unit defines numerical relationship factors relating “MY VOICE” to “YOUR VOICE”. As the memory is filled with bytes of 10 millisecs the process of digital data conversion starts 86, and the voice parameters of “MY VOICE” are multiplied by the numerical relationship factors to produce the “CHOSEN VOICE” 88.

The voice packets being processed in turn are small enough, and processing and broadcasting are fast enough, to ensure that the delay between the operator speaking and the “CHOSEN VOICE” output is short enough to be practically imperceptible.

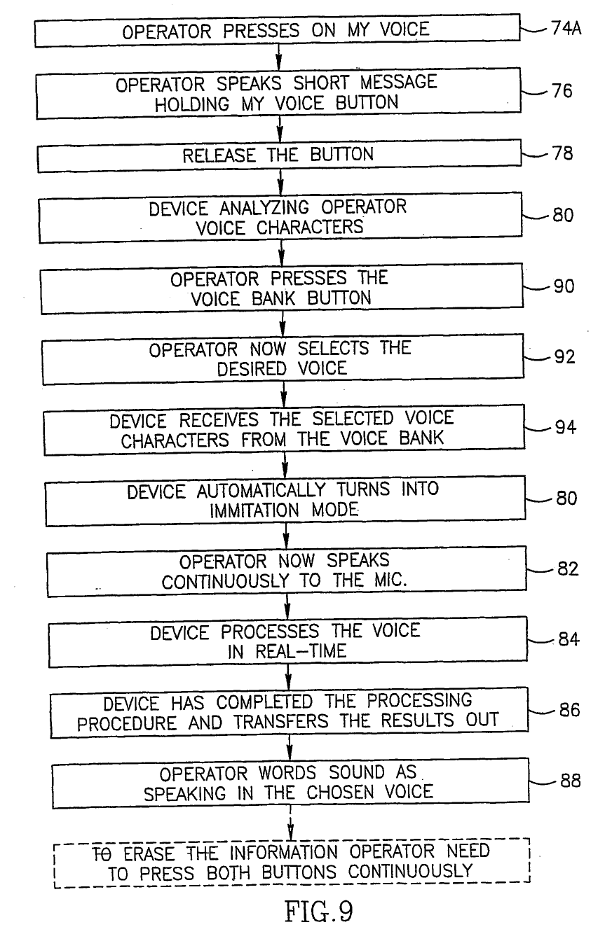

Referring now to FIG. 9, there is depicted a representation of a speech transformation system using a voice bank which stores speech characteristics of persons of interest. The voice bank has previously been briefly referred to with reference to FIG. 1.

The operating procedure is identical to that described with reference to FIG. 8, except that the second voice is replaced by a selectable existing voice stored in the data bank.

The stored speech characteristics are selectable 90-92 as input to the digital processing unit to optionally substitute for input originating from the second person. The device receives voice characteristics data from the data bank, and the process continues exactly as described with reference to FIG. 8.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. An improved speech transformation system for converting vocal output of a first person into speech as would be heard if spoken by a second person, the system comprising:
a) means for loading speech samples into a storage memory, said memory being connected to a digital processing unit;
b) means for recording speech samples by said first and by a second person, and means for analysis of said speech, said analysis including at least two of the group of five voice characteristics, said group comprising pitch, voice, unvoice, silence, and energy, said analysis being converted to digital form and being accessible by said digital processing unit;
c) a program for directing operation of said digital processing unit to produce conversion factors for converting said vocal output of said first person into speech signals as would be produced if spoken by said second person; and
d) vocal output means for receiving processed signals from said digital processing unit, for broadcasting speech by said first person in a third person manner, said third person manner speech sounding as if spoken by said second person

2. The speech transformation system as claimed in claim 1, wherein said means for loading speech samples into a storage memory comprises a microphone.

3. The speech transformation system as claimed in claim 1, wherein said vocal output means comprises a loudspeaker.

4. The speech transformation system as claimed in claim 1, wherein said means for loading speech is connectable to an analogue/digital converter and stored for subsequent processing in a digital storage memory.

5. The speech transformation system as claimed in claim 1, wherein the recorded speech signals of both said first and second persons are sliced by software and hardware for purposes of said analysis into adjoining segments no larger than 10 milliseconds each.

6. The speech transformation system as claimed in claim 1, further comprising a voice bank storing speech characteristics of persons of interest, said stored speech characteristics being selectable as input to said processing unit to substitute for input originating from said second person.

7. The speech transformation system as claimed in claim 1, wherein said processing unit is the central processing unit of a personal computer, said vocal output means is the Sound Card of said personal computer, and said program being available on a disk acceptable by said computer.

8. The speech transformation system as claimed in claim 1, wherein said central processing unit is part of a server connected through a controller in a closed network to multiple network computers, each of which has loading means for voice input and a vocal output means for resultant output.

9. The speech transformation system as claimed in claim 1, wherein said central processing unit is part of a server connected through a controller in an open network to computers connected to the internet, each computer having a connected microphone for voice input and a loudspeaker for resultant output.

10. An improved speech transformation system substantially as described hereinbefore and with reference to the accompanying drawings.

11. A portable speech conversion device, comprising a housing containing an electronic board including all modules needed to execute speech conversion, a microphone, a battery, a loudspeaker, and user controls.

12. The portable speech conversion device as claimed in claim 11, further including at least one status-indicating light.

13. A portable speech conversion device substantially as described hereinbefore and with reference to the accompanying drawings.
